(19) United States
(12) Patent Application Publication
(10) Pub. No.: US 2015/0037523 A1
(43) Pub. Date: Feb. 5, 2015

(54) HEAT-REFLECTIVE ADHESIVE PRODUCT HAVING HIGH ABRASION-RESISTANCE

(71) Applicant: tesa SE, Hamburg (DE)

(72) Inventors: Steven Eugene Zielinski, Brighton, MI (US); Dean Thomas Dupont, Rockford, MI (US)

(73) Assignee: tesa SE, Hamburg (DE)

(21) Appl. No.: 14/336,323

(22) Filed: Jul. 21, 2014

Related U.S. Application Data
(60) Provisional application No. 61/859,877, filed on Jul. 30, 2013.

(51) Int. Cl. B32B 1/08; H01B 7/02; B32B 17/06; B32B 17/08; B32B 7/12; B32B 15/20

(52) U.S. Cl. CPC B32B 1/08; B32B 7/12; B32B 15/20; B32B 17/061; B32B 17/064; B32B 17/08; H01B 7/0241; B32B 2307/304; B32B 2307/584; B32B 2457/00; B32B 2597/00
USPC 428/35.2; 29/428

(57) ABSTRACT

Disclosed is an adhesive product useful to protect elongate material, for example, leads and cable harnesses, from ambient heat. The adhesive product has the form generally of a tube when expanded, or of a tape when flattened. The adhesive product has an outer surface and an inner surface, the inner surface defining a cylindrical interior space when the adhesive product is expanded, and, for all practical purposes, being non-existent when the adhesive product is fully flattened. The outer surface of the adhesive product is heat-reflective, and the inner surface is abrasion-resistant. In this embodiment, the cylindrical interior space is empty yet fillable. Also disclosed is a method of protecting an elongate material in need of protecting from ambient heat. The method comprises sliding the inventive adhesive product over said elongate material.

### BACKGROUND OF THE INVENTION

1. Field of the Invention

The present invention relates to a heat-reflective, abrasion-resistant adhesive product useful to protect elongate material, for example, leads or cable, or other materials needing protection from ambient heat.

2. Description of Related Art

In numerous sectors of industry, bundles composed of a multiplicity of electrical leads are wrapped, either before installation or when already mounted, in order to reduce the space taken up by the bundle of leads, by means of bandaging, and also to obtain protective functions. With sheet adhesive tapes a certain protection against ingress of liquid is achieved; with airy and bulky adhesive tapes based on thick nonwovens or foam backings, damping properties are obtained; and when stable, abrasion-resistant backing materials are used, a protective function against scuffing and rubbing is achieved. Protection against radiant heat, however, is not offered by such adhesive tapes.

In order to demonstrate a material of construction's compliance with the existing requirements for electrical leads and other components for cable harnesses, a variety of checks and tests are prescribed, and have been summarized in forms which include a works standard agreed between different car makers (LV112-low-voltage leads for motor vehicles, June 2004 version). According to this standard, the material of construction used for insulating the leads shall meet the requirements of VDA 231-106. The minimum and maximum sustained use temperatures (T_{U} and T_{O}) for an exposure time of 3000 h are −40° C. and 100° C. for classification into temperature class B, for example, the material having to withstand a short-term temperature (240 hours) of 125±3° C. and an overload temperature (6 hours) of 150±3° C.

Protection against radiant heat is generally accomplished by means of insulating layers having a low thermal conductivity. In the case of cable harnesses, this end is frequently served by recourse to temperature-resistant sleeves such as convoluted tubes, silicone hoses or metal-armored glass fabric hoses, which, however, do not afford adequate protection for relatively high loads.

For specialty applications there also exist what are known as heat reflection tapes, which are adhesive tapes of the type specified at the outset. These tapes are composed of a glass fiber fabric (second backing layer) which is laminated with an aluminum foil (first backing layer) and provided on the reverse with a highly temperature-resistant silicone adhesive. Products of this kind are offered, for example, by the companies Tyco and Aremco, New York. Disadvantages of these tape products, however, include the high rigidity of the backing and also the high price as compared with conventional adhesive tapes.

EP 1 615 238 A1 discloses a thermally insulating adhesive tape for the wrapping of elongate material such as, more particularly, leads or cable harnesses, which has a tape-like backing. The backing is composed of an assembly of at least one first layer and at least one second layer, the first layer being a metallic layer. On one side of the backing a pressure-sensitive adhesive coating is applied. The second layer of the backing is formed by a polymeric film that is resistant up to a temperature of at least 175° C. or by a textile backing material which is resistant up to a temperature of at least 175° C.

Adhesive tapes of this kind, also called heat-reflective adhesive tapes, are known. Since for the thermal reflection effect the adhesive tapes are wrapped with an overlap around cables, for example, the rigidity of the known adhesive tapes, which is attributable more particularly to the thick metal layers used, has a particularly negative effect. Moreover, the unwind force of the adhesive tapes is high, resulting in an increased wrapping pressure, and the cable harness becomes particularly inflexible and exhibits disadvantageous properties for transit and installation. The slower wrapping operation that is a result of this leads to higher costs.

Additionally there are aluminized or aluminum-clad braided hoses known (from Bentley Harris, for example), but in application these hoses again produce a cable harness of very low flexibility (see U.S. Pat. No. 5,843,542 A1 or U.S. Pat. No. 5,849,379 A1). The protection of cables with usually preformed specialty products of this kind proves not to be economic, since the costs for the aforementioned heat protection measures are higher than if leads and components were to be used which satisfy the requirements per se even without such protective measures.

Nor is the use of the thermally insulating, spirally wound adhesive tapes an adequate solution, because winding produces cable harnesses with a low flexibility. As a result there are difficulties associated with transport, and in the course of packaging there is damage to the heat-reflecting metal layer. The subsequent installation of the cable harness and its bending into the necessary shapes are made more difficult by the lack of flexibility. Possible damage to the functional capacity of the cable harness even during these operations, however, must absolutely be avoided.

The abrasion-resistance is a measure of the scuff resistance of adhesive tapes. An established method of determining the abrasion-resistance of protection systems in vehicle electrics is the international standard ISO 6722, section 9.3 “Scrape abrasion test” (April 2002 version). In this test the test specimen (for example the insulated copper lead or else the wrapping tape adhered to a metal mandrel) is exposed to a thin steel wire under a defined weight load and with defined stroke geometries until the protective casing has been rubbed through and, as a result of a short circuit, the counter which runs at the same time comes to a stop.

US 2008/0286568 describes a heat-reflecting adhesive tape, preferably for wrapping elongate material such as, more particularly, leads or cable harnesses, having a tape-like backing composed of an assembly comprising at least one first layer, formed by a glass fabric having a basis weight of 30 to 200 g/m², and at least one second layer, formed by a metallic layer having a thickness of 10 to 40 μm and a thermal effectiveness to SAE J2302 at 350° C. of greater than 45° C., having a pressure-sensitive adhesive coating applied at least to one side of the backing, and at least one stripe of a covering which is provided on the free side of the adhesive coating and which extend(s) in the longitudinal direction of the adhesive tape and which cover(s) between 20% and 90% of the adhesive coating. The presence of the stripe affords high abrasion-resistance as demonstrated in the automotive testing guideline LV 312.

Heat-reflecting adhesive tapes with high abrasion-resistance for wrapping elongate material are also described in US 2008/0261012.

A disadvantage of all of these prior adhesive tapes is that the cable must be wrapped with them, usually by, for example, the automobile manufacturer, and this is time consuming and slows down production. Accordingly, there is a need for a more efficient solution to the problem of providing leads and cable harnesses with adequate protection from ambient heat yet with good abrasion-resistance.

### SUMMARY OF THE INVENTION

These and other objects were met with the present invention, which relates in a first embodiment to an adhesive product. The adhesive product has the form generally of a tube when expanded, or of a tape when flattened. The adhesive product has an outer surface and an inner surface, and at least one adhesive between the outer surface and the inner surface. The inner surface defines a cylindrical interior space when the adhesive product is expanded, and, for all practical purposes, is nonexistent or evacuated when the adhesive product is fully flattened. The outer surface of the adhesive product is heat-reflective, and the inner surface is abrasion-resistant. In this first embodiment, the cylindrical interior space is empty yet fillable.

The invention relates in a second embodiment to a method of protecting an elongate material in need of protecting from ambient heat. The method comprises sliding the inventive adhesive product over said elongate material. Once the inventive adhesive product is slid over the elongate material, the elongate material will be adequately protected from ambient heat, and the high abrasion-resistance of the inventive adhesive product will ensure that the elongate material will be safe from rubbing damage.

### BRIEF DESCRIPTION OF THE DRAWINGS

The invention will now be described in greater detail with reference to the drawings, wherein:

FIG. 1 shows one embodiment of the invention, particularly an adhesive product as described herein, in this particular embodiment, fully expanded to a tube, the tube being constructed of spiral windings of a heat-reflective adhesive tape adhered on top of spiral windings of an abrasion-resistant adhesive tape; and

FIG. 2 shows a cross-section of the embodiment of FIG. 1.

### DETAILED DESCRIPTION OF THE INVENTION

In one preferred embodiment, the inventive adhesive product is constructed of spiral windings of a heat-reflective adhesive tape adhered on top of spiral windings of an abrasion-resistant adhesive tape. Heat-reflective adhesive tapes and materials used to construct them are well known in the art, for example, from US 2008/0261012 and US 2008/0286568, the entire contents of which are incorporated herein by reference. Abrasion-resistant adhesive tapes and the materials used to construct them are also well known in the art, for example, from US 2011/0027552 and US 2012/0238172, the entire contents of which are also incorporated herein by reference.

In an especially preferred embodiment, the heat-reflective adhesive tape comprises a tapelike backing composed of an assembly comprising at least one first layer, formed by a glass fabric having a basis weight of 30 to 200 g/m², and at least one second layer, formed by a metallic layer having a thickness of 10 to 40 μm and a thermal effectiveness to SAE J2302 at 350° C. of greater than 45° C., and having a pressure-sensitive adhesive coating applied at least to one side of the backing The flexural rigidity of the adhesive tape in longitudinal and transverse direction is less than 500 mN, preferably less than 300 mN (as measured with a Softometer KWS basic 2000 mN from Wolf).

The properties of the glass fabric of the first layer are advantageously as follows:

the basis weight is from 80 to 120 g/m²;

the number of filaments in longitudinal and transverse direction is in each case 3 to 10 filaments/cm; and/or

the filaments used to form the glass fabric have a linear density of less than 150 tex, preferably less than 100 tex.

According to a further advantageous embodiment of the invention the metallic layer has a thickness of 12 to 20 μm. Where appropriate it further comprises embossing.

Metals which can be chosen include silver, copper, gold, platinum, aluminum and compounds of aluminum, tin, Ni chrome, NIROSTA, titanium, and metal oxides such as cadmium oxides, tin oxides, zinc oxides and magnesium oxides, but preferably aluminum. This list is not regarded as being conclusive instead, the skilled person is able to choose further metal layers, not explicitly specified here, without departing from the concept of the invention.

In order to produce a self-adhesive heat-reflective tape from the backing it is possible to employ all known adhesive systems. Besides natural or synthetic rubber based adhesives it is possible more particularly to use silicone adhesives and also polyacrylate adhesives. Preferred on account of their particular suitability as an adhesive for wrapping tapes for automotive cable harnesses, in respect of the absence of fogging and also the outstanding compatibility with both PVC and PVC-free core insulations, are solvent-free acrylate hotmelt compositions, as described in more detail in DE 198 07 752 A1 and also DE 100 11 788 A1.

The application weight is situated in the range between 20 to 100 g/m².

The coating technology employed involves known systems, appropriate processes being those which permit an unpressurized placement of highly viscous adhesives, such as, for example, the coating of hotmelt adhesives via nozzle coating or via transfer from an anti-adhesive support cloth or release liner onto the backing assembly.

A suitable adhesive is one based on acrylate hotmelt with a K value of at least 20, more particularly greater than 30 (measured in each case in 1% strength solution in toluene, 25° C.), obtainable by concentrating a solution of such a composition to give a system which can be processed as a hotmelt. Concentration may take place in appropriately equipped tanks or extruders; more particularly in the case of accompanying devolatilization, a devolatilizing extruder is preferred. One such adhesive is set out in DE 43 13 008 C2. In an intermediate step, the solvent is removed completely from the acrylate compositions prepared in this way. The K value is determined more particularly in analogy to DIN 53 726.

Additionally, in the course of this process, further volatile constituents are removed. After coating from the melt, these compositions have only small residual fractions of volatile constituents. Accordingly it is possible to take on all of the monomers/formulas that are claimed in the patent cited above. The solution of the composition may contain 5% to 80% by weight, more particularly 30% to 70% by weight, of solvent. Preference is given to using commercially customary solvents, more particularly low-boiling hydrocarbons, ketones, alcohols and/or esters. Further preference is given to using single-screw, twin-screw or multi-screw extruders having one or, more particularly, two or more devolatilizing units. The acrylate hotmelt-based adhesive may have had benzoin derivatives incorporated into it by copolymerization: for example, benzoin acrylate or benzoin methacrylate, acrylic or methacrylic esters. Benzoin derivatives of this kind are described in EP 0 578 151 A. The acrylate hotmelt-based adhesive may be UV-crosslinked. Other types of crosslinking are also possible, however, an example being electron beam crosslinking. In a further preferred embodiment the self-adhesive compositions employed are copolymers of (meth)acrylic acid and the esters thereof having 1 to 25 C atoms, maleic, fumaric and/or itaconic acid and/or their esters, substituted (meth)acrylamides, maleic anhydride and other vinyl compounds, such as vinyl esters, more particularly vinyl acetate, vinyl alcohols and/or vinyl ethers. The residual solvent content ought to be below 1% by weight.

One adhesive which is found to be particularly suitable is a low molecular mass, pressure-sensitive, acrylate hotmelt adhesive of the kind carried under the name acResin UV or ACRONAL®, more particularly ACRONAL® DS 3458, by BASF. This adhesive, with a low K value, acquires its application-compatible properties through a concluding, radiation-induced crosslinking operation.

Preferably, therefore, the adhesive coating of the heat-reflective adhesive tape is composed of an adhesive comprising acrylate or silicone.

The adhesive may be applied in the longitudinal direction of the heat-reflective adhesive tape, in the form of a stripe whose width is lower than that of the adhesive tape backing. In one advantageous embodiment the coated stripe has a width of 10% to 80% of the width of the backing material. Particular preference is given to using stripes having a coating of 20% to 50% of the width of the backing material. Depending on the particular utility it is also possible for two or more parallel stripes of the adhesive to be coated on the backing material. The position of the stripe on the backing is freely selectable, preference being given to an arrangement directly at one of the edges of the backing.

Furthermore, the first layer and/or the adhesive coating may have been made flame retardant by means, for example, of a flame retardant composed of ammonium polyphosphate, magnesium hydroxide and/or aluminum hydroxide or by means of a chlorinated paraffin, where appropriate in combination with antimony trioxide.

In a most preferred embodiment, the heat-reflective adhesive tape comprises a backing construction of aluminum foil and glass cloth and this backing is combined with a solvent-free acrylic adhesive, for example, tesa® 68000 PVO or tesa® 68000 PV7, the latter having a thin polyethylene terephthalate (PET) fleece layer that provides noise, vibration and harshness (NVH) protection.

In an especially preferred embodiment, the abrasion-resistant adhesive tape comprises a carrier material which is provided at least on one side with an adhesive coating, where the carrier material consists of a laminate, the laminate being formed from a textile carrier in the form of a staple fiber nonwoven web or a spunbonded nonwoven web and from a film which is located on the underside of the textile carrier and is made preferably of polyolefins, TPU or PVC such as plasticized PVC, more preferably of polyolefins, the film having a thickness of 15 to 80 μm.

Nonwovens contemplated include, in particular, staple fiber webs, preferably wet-laid webs, needle-punched webs or water jet webs, and also spunbonded webs, which in one preferred embodiment are additionally consolidated.

Starting materials stated for the carrier include, in particular, (manmade) fibers (staple fiber or continuous filament) of synthetic polymers, also called synthetic fibers, of polyester, polyamide, polyimide, aramid, polyolefin, polyacrylonitrile or glass, (manmade) fibers based on natural polymers, such as cellulosic fibers (viscose, Modal, Lyocell, Cupro, acetate, triacetate, Cellulon, rayon), such as rubber fibers, such as plant protein fibers and/or such as animal protein fibers and/or natural fibers made of cotton, sisal, flax, silk, hemp, linen, coconut or wool. The present invention, however, is not confined to the materials stated; it is instead possible, as evident to the skilled person without having to take an inventive step, for a multiplicity of further fibers to be used for producing the nonwoven web.

Preferred as material for the carrier is polyester, for example, polyethylene terephthalate (PET), on account of the excellent ageing resistance and the outstanding media resistance with respect to chemicals and service fluids such as oil, petrol, antifreeze and the like. Polyester, furthermore, has the advantages that it leads to a highly abrasion-resistant and temperature-resistant carrier, which is particularly important for the specific end use for the bundling of cables in motor vehicles and, for example, in the engine compartment.

In accordance with one first advantageous embodiment, the adhesive coating is on the free side of the film.

Indicated below are preferred parameters for the individual layers of the carrier material, without any intention thereby to impose a restriction on the invention.

If the textile carrier used is a spunbonded web (spunbond), the basis weight is preferably 15 to 50 g/m², more preferably from 15 to 40 g/m².

If a wet-laid web is used, the basis weight is preferably 25 to 60 g/m², more preferably 25 to 50 g/m².

If a needle-punched web is used, the basis weight is preferably 25 to 60 g/m², more preferably 25 to 50 g/m².

If a water jet web (spunlace) is used, the basis weight is preferably 15 to 50 g/m², more preferably 15 to 40 g/m².

The film is preferably a thermoplastic single-layer or multi-layer film manufactured in extrusion (especially blown-film extrusion). Alternatively it may be a calendered single-layer film. With further preference, the blowing ratio is at least 1:1.5, especially 1:2 or more. By blowing ratio is meant the factor by which the diameter of the inflated film partition is greater than the die diameter, for a constant take-off speed.

Any polyolefin used is preferably a polyethylene.

The film and the web are joined using laminating adhesives, preferably reactive 1- or 2-component PU adhesives.

According to a further advantageous variant of the invention, polyolefin-based thermoplastic laminating adhesives may be used.

The coatweight is preferably 3 to 15 g/m², more preferably 5 to 10 g/m².

Producing an abrasion-resistant adhesive tape from the carrier can be done using any known adhesive systems in exactly the same manner as set forth above for the heat-reflective adhesive tape. As was the case with the heat-reflective adhesive tape, it is most preferable to use acrylic based adhesives, especially acrylate hot melt adhesives.

In a most preferred embodiment, the abrasion-resistant comprises a PET cloth or rayon fabric backing coated with an acrylic based adhesive, for example, tesa® 4671 (acrylic coated rayon tape) or tesa® 51026 (acrylic coated PET cloth tape).

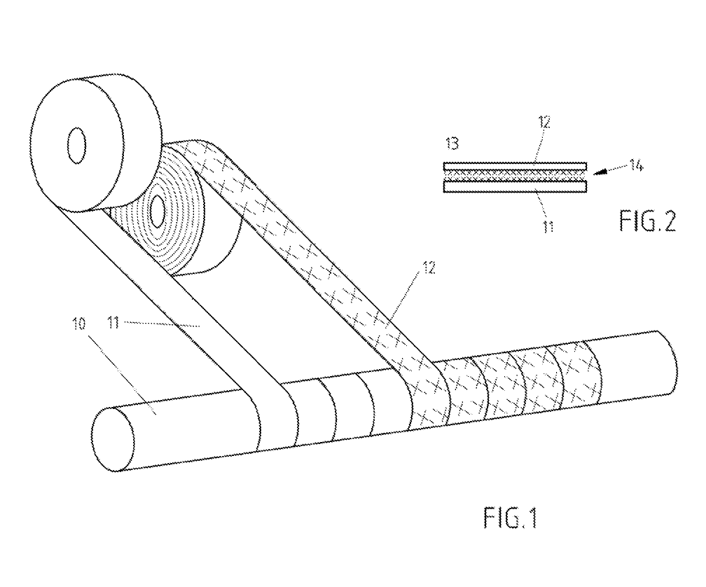

Referring to FIG. 1, a mandrel 10 or tube or dowel of suitable diameter can be used to construct the inventive adhesive product. The diameter can be selected with an eye to the end use, i.e., the diameter should be sufficient so that the interior space that is formed when expanded will be large enough to cover the leads or cables intended to be protected within the inventive adhesive product. The abrasion-resistant adhesive tape 11 is wound around the mandrel 10 with its abrasion-resistant side contacting the mandrel surface and its adhesives side facing away from the mandrel surface. The heat-reflective adhesive tape 12 is then wound on top of the abrasion-resistant adhesive tape 11, the adhesive side of the heat-reflective adhesive tape 12 being adhered to the adhesive side of the underlying abrasion-resistant adhesive tape 11. The resulting construct 13, shown in cross-section in FIG. 2, is characterized by an inner abrasion-resistant surface and an outer heat-reflective surface, with two layers of adhesive 14 adhered to one another between the inner and outer surfaces.

Alternatively, it is possible to omit one of the adhesive layers. For example, an abrasion-resistant adhesive tape could be wound on top of the mandrel as discussed. Then, instead of overwrapping with a heat-reflective adhesive tape, the abrasion-resistant adhesive tape could be overwrapped with non-adhesive, heat-resistant material. The resulting construct would again be characterized by an inner abrasion-resistant surface and an outer heat-reflective surface, but with only one adhesive layer between the inner and outer surfaces. Similarly, it should also be possible to wrap the mandrel with non-adhesive, abrasion-resistant material and then overwrap the non-adhesive, abrasion-resistant material with the heat-reflective adhesive tape.

In a particularly preferred embodiment, the heat-reflective adhesive tape is tesa® 68000 PVO or tesa® 68000 PV7; and the abrasion-resistant adhesive tape is tesa® 4671 or tesa® 51026. In one most preferred embodiment, the construct contains both adhesive layers of the heat-reflective adhesive tape and the abrasion-resistant adhesive tape so that the construct has a layer sequence of heat-reflective surface—adhesive layer 1—adhesive layer 2—abrasion-resistant surface. In a second most preferred embodiment, one of the two adhesive layers has been eliminated so that the construct has the layer sequence heat-reflective surface—single adhesive layer—abrasion-resistant surface.

In one embodiment, the present invention relates to the expanded inventive adhesive product, which is, therefore, prepared and ready to encase and protect leads and cables.

In another embodiment, the present invention relates to the flattened inventive adhesive product, which is, therefore, well suited to storage and transport. In a preferred embodiment, the flattened inventive adhesive product is rolled into a roll for easy storage and transport. When it is time to use the inventive adhesive product for encasing and protecting leads and cables, the roll can be unwound and a length of said adhesive product cut from said roll, expanded to form a tube, and then slid over the leads or cables.

The present invention relates in a further embodiment to the construct that results from sliding the inventive adhesive product over elongate material, especially leads and cable.

The present invention relates in a further embodiment to a product, for example, an automobile, having such a construct as a part of its makeup.

The invention will now be described in greater detail with reference to the following examples:

### EXAMPLES

### Example 1

On a winding mandrel, tesa® 4671 (acrylic coated rayon tape) is wound, adhesive side up, the windings overlapping each other approximately ⅛″ on each side. On top of this, tesa® 68000 PVO (acrylic coated aluminum foil/glass cloth tape) is wound, adhesive side down, the windings again overlapping each other approximately ⅛″ on each side. The resulting construct, having a layer sequence aluminum foil/glass cloth—acrylic adhesive layer 1—acrylic adhesive layer 2—rayon, is removed from the mandrel and flattened and rolled for later use. When desired, the rolled construct is unrolled, expanded to permit access to the interior space and then slid over leads or cables, thereby providing both protection from ambient heat and high abrasion-resistance.

### Example 2

On a winding mandrel, tesa® 51026 (acrylic coated PET cloth tape) is wound, adhesive side up, the windings overlapping each other approximately ⅛″ on each side. On top of this, an aluminum foil/glass cloth laminate is wound, the windings again overlapping each other approximately ⅛″ on each side. The resulting construct, having a layer sequence aluminum foil/glass cloth—acrylic adhesive layer—PET cloth, is removed from the mandrel and flattened and rolled for later use. When desired, the rolled construct is unrolled, expanded to permit access to the interior space and then slid over leads or cables, thereby providing both protection from ambient heat and high abrasion-resistance.

It should be understood that the preceding is merely a detailed description of one preferred embodiment or a small number of preferred embodiments of the present invention and that numerous changes to the disclosed embodiment(s) can be made in accordance with the disclosure herein without departing from the spirit or scope of the invention. The preceding description, therefore, is not meant to limit the scope of the invention in any respect. Rather, the scope of the invention is to be determined only by the appended issued claims and their equivalents.

What is claimed is:

1. An adhesive product that can be expanded from a flattened state and flattened from an expanded state, said adhesive product having the form generally of a tube when expanded, or of a tape when flattened, the adhesive product comprising an outer surface and an inner surface, and at least one adhesive between said outer surface and said inner surface, said inner surface defining a generally cylindrical interior space when the adhesive product is expanded, said outer surface being heat-reflective, said inner surface being abrasion-resistant, and said generally cylindrical interior space being empty but fillable.

2. The adhesive product according to claim 1, which is constructed of spiral windings of a heat-reflective adhesive tape adhered on top of spiral windings of an abrasion-resistant adhesive tape.

3. The adhesive product according to claim 1, which is expanded.

4. The adhesive product according to claim 1, which is flattened.

5. The adhesive product according to claim 4, which is rolled into a roll.

6. The adhesive product according to claim 1, wherein the outer surface is a layered combination of aluminum foil and glass cloth.

7. The adhesive product according to claim 1, wherein the inner surface is rayon or polyethylene terephthalate.

8. The adhesive product according to claim 1, wherein the at least one adhesive is an acrylic-based adhesive.

9. A method of protecting an elongate material in need of protecting from ambient heat, said method comprising sliding an adhesive product according to claim 1 over said elongate material.

10. The method according to claim 9, which further comprises providing a roll of said adhesive product, unwinding and cutting a length of said adhesive product from said roll, expanding the adhesive product to form a tube, and then sliding said tube formed from the adhesive product over said elongate material.

11. A heat-reflective product obtained by the method according to claim 9.

12. An automobile comprising a heat-reflective product according to claim 11.
